(19) United States
(12) Patent Application Publication
(10) Pub. No.: US 2016/0050101 A1
(43) Pub. Date: Feb. 18, 2016

(54) Real-Time Network Monitoring and Alerting

(71) Applicant: Microsoft Corporation, Redmond, WA (US)

(72) Inventors: Adwait Vaidya, Redmond, WA (US); Nicholas Robarge, Redmond, WA (US); Ted W. Way, Redmond, WA (US); Adam K. Mihalcin, Redmond, WA (US); Bhumil Haria, Redmond, WA (US); Ritu Singh, Bellevue, WA (US); Dula Kumela, Redmond, WA (US); Pramit Gupta, Redmond, WA (US); Rajesh Srinivasan, Redmond, WA (US)

(73) Assignee: MICROSOFT CORPORATION, Redmond, WA (US)

(21) Appl. No.: 14/462,537

(22) Filed: Aug. 18, 2014

(51) Int. Cl. H04L 12/24

(52) U.S. Cl. CPC H04L 41/0622; H04L 41/0681

(57) ABSTRACT

In one embodiment, a real-time data analysis system 160 may efficiently alert a service technician 170 about any service outages for a network service 120. The real-time data analysis system 160 may process a service signal 410 from an application interacting with a network service 120. The real-time data analysis system 160 may determine that the service signal 410 crosses a failure threshold 430 indicating an emergency event. The real-time data analysis system 160 may send an emergency alert about the emergency event.

### BACKGROUND

A network service may provide a data service accessible by multiple users via a data network. The data service may be file storage, communications, software as a service, and other computing tasks. The network service may be maintained by a server farm, or a set of one or more servers operating in concert to implement the network service. A service technician may be available to fix any issues that may arise, such as network outages or service errors.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a real-time data analysis system that efficiently alerts a service technician about any service outages for a network service. The real-time data analysis system may process a service signal from an application interacting with a network service. The real-time data analysis system may determine that the service signal crosses a failure threshold indicating an emergency event. The real-time data analysis system may send an emergency alert about the emergency event.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing network.

FIG. 2 illustrates, in a block diagram, one embodiment of a computing device.

FIG. 3 illustrates, in a block diagram, one embodiment of a real-time data analysis interaction.

FIG. 4 illustrates, in a line graph, one embodiment of a real-time data analysis of a service signal.

FIG. 5 illustrates, in a flowchart, one embodiment of a method of generating a client usage telemetry data set with a network service client.

FIG. 6 illustrates, in a flowchart, one embodiment of a method of generating a service signal with a telemetry agent.

FIG. 7 illustrates, in a flowchart, one embodiment of a method of generating a service signal with an active monitoring service.

FIG. 8 illustrates, in a flowchart, one embodiment of a method of processing a service signal at a real-time data analysis system.

FIG. 9 illustrates, in a flowchart, one embodiment of a method of processing a service signal at a real-time data analysis system.

FIG. 10 illustrates, in a flowchart, one embodiment of a method of executing an alert protocol at a real-time data analysis system.

FIG. 11 illustrates, in a flowchart, one embodiment of a method of repairing a network service with a service technician.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a real-time data analysis system.

An owner of a network service may seek to know when the network service is not available, preventing a customer from using the service. A service owner may seek timely alerts to catch and fix issues quickly. A service owner may seek accurate alerts to filter out spurious noise. By sending data in real time for complex event processing, a service owner may make a decision based on more accurate data. Passive data from application clients may be available as one data source to alert a service owner of any issues.

An active monitoring service may probe a network service at a predefined execution interval, such as every 5 minutes. The active monitoring service may probe the network service by sending a hypertext transfer protocol request to the network service and monitor the timing and quality of the response. The active monitoring service may log the response to the probes. The results may be sent to a real-time data analysis system for aggregation.

The active monitoring service may probe multiple datacenters worldwide. The real-time data analysis system may review the most recent probe results from this specific probe every 30 seconds. If the number of probe failures relative to the total number of probe results is below a performance benchmark for a set failure threshold, such as more than three times in a row, the real-time data analysis system may send an alert to the predefined team. If this probe is failing consistently, then the real-time data analysis system may suppress additional alerts for as long as the condition for failure continues to be met. In this way, a service technician is not overwhelmed by emergency alerts.

Thus, in one embodiment, a real-time data analysis system may efficiently alert a service technician about any service outages for a network service. The real-time data analysis system may process a service signal from an application interacting with a network service. The real-time data analysis system may determine that the service signal crosses a failure threshold indicating an emergency event. The real-time data analysis system may send an emergency alert about the emergency event. The real-time data analysis system may suppress a successive alert about the emergency event.

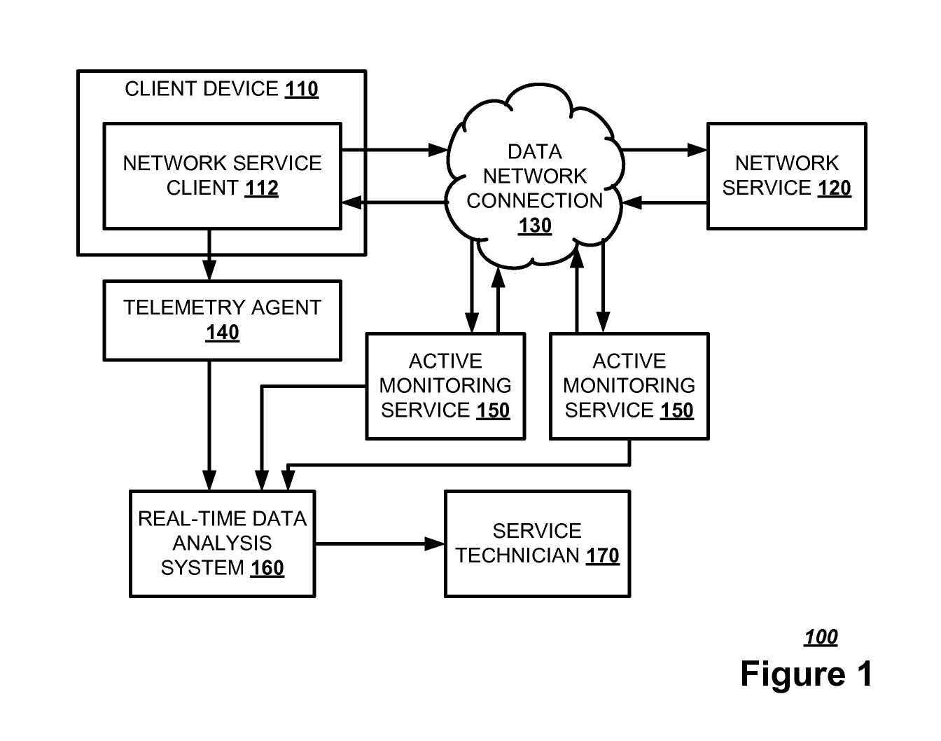

FIG. 1 illustrates, in a block diagram, one embodiment of a data network 100. A client device 110 may execute a network service client 112 to connect to a network service 120 via a data network connection 130. The network service client 112 may be a separate application or integrated into an operating system or an internet browser platform. The network service 120 may refer to a single server or a distributed set of servers that may access the cloud data set, such as a server farm. The data network connection 130 may be an internet connection, a wide area network connection, a local area network connection, or other type of data network connections.

The network service client 112 may produce a set of client usage telemetry data describing the performance of the network service 120. For example, the client usage telemetry data set may describe the speed of the network service response to a network service access request, the completeness of the response, and other service metrics. The network service client 112 may send the client usage telemetry data set to a telemetry agent 140. The telemetry agent 140 may gather client usage telemetry data sets from multiple network service clients 112. The network service client 112 may anonymize the client usage telemetry data set by removing any personally identifiable information of the user prior to the sending the client usage telemetry data set to the telemetry agent 140. The telemetry agent 140 may perform further anonymization upon receiving a client usage telemetry data set. Each region serviced by the network service 120 may have a telemetry agent 140 collecting the client usage telemetry data set.

An active monitoring service 150 may monitor the performance of the network service 120. The active monitoring service 150 may send a network probe to the network service 120 at regular intervals. The network service 120 may then send a probe response to the active monitoring service 150. The active monitoring service 150 may measure the time between sending the network probe and receiving the probe response. Additionally, the active monitoring service 150 may request specific data in the network probe, and measure the response provided by the probe response. Each region serviced by the network service 120 may have at least one active monitoring service 150 checking network quality. The active monitoring system 150 may collect this data as an active synthetic data set. An active synthetic data set is data generated for the purpose of testing the network service 120, rather than a client usage telemetry data set gathered in the normal course of using the network service 120.

Each telemetry agent 140 may send the client usage telemetry data set in a service signal to a real-time data analysis system 160. Alternately, the real-time data analysis system 160 may receive the client usage telemetry data set directly from the network service client 112. Additionally, each active monitoring system 150 may send the active synthetic data set in a service signal to a real-time data analysis system 160.

The real-time data analysis system 160 may process the service signal to detect an emergency event. The real-time data analysis system 160 may determine that the service signal crosses a failure threshold indicating an emergency event. The failure threshold indicates the number of failure events that may occur before the real-time data analysis system 160 characterizes the event as an emergency event. The real-time data analysis system 160 may adjust the failure threshold if the failure events indicate location diversity, or failure events from multiple regions.

The real-time data analysis system 160 may send an emergency alert about the emergency event to a service technician 170. An emergency alert is an alert sent upon detection of an emergency event. The emergency alerts may be an intrusive transmission, such as a text, an automated telephone call, or other notice that immediately alerts the service technician 170. The real-time data analysis system 160 may suppress any successive alerts about the emergency event to the service technician until the service status of the network service 120 is reset by the service technician 170. The real-time data analysis system 160 may send a status update indicating the status of the network while in the emergency state. A status update compiles a number of event notices. The status update may be a passive transmission, such as a forum posting, an e-mail, or other notice that does not interrupt the service technician 170. Once the service technician 170 has reset the service status for the network service 120, the real-time data analysis system 160 may again send an emergency alert.

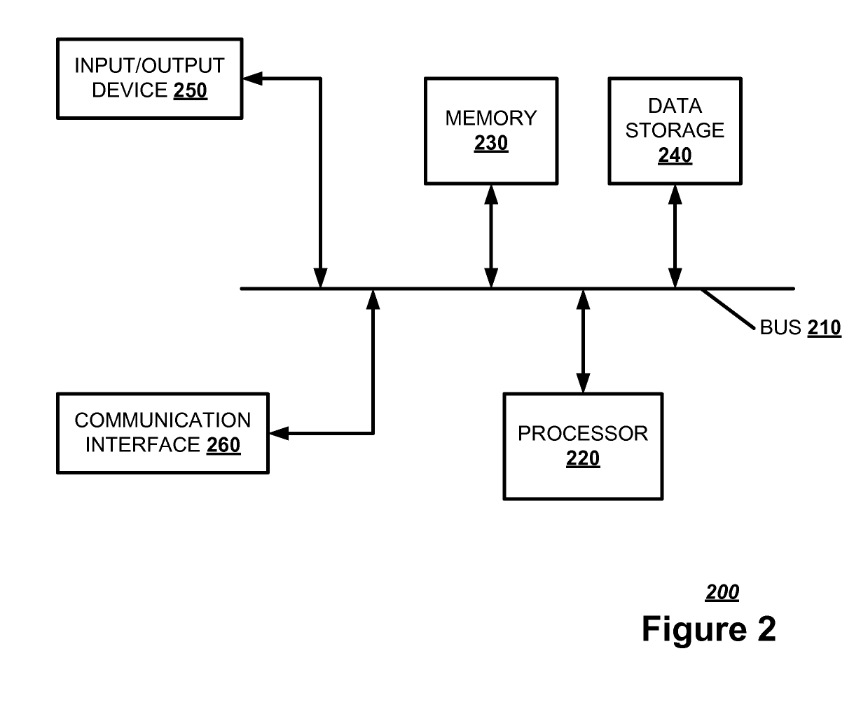

FIG. 2 illustrates a block diagram of an exemplary computing device 200 which may act as a client device 110, a network service 120 server, a telemetry agent 140, an active monitoring service 150, a real-time data analysis system 160, or a service technician 170 device. The computing device 200 may combine one or more of hardware, software, firmware, and system-on-a-chip technology to implement a client device 110, a network service 120 server, a telemetry agent 140, an active monitoring service 150, a real-time data analysis system 160, or a service technician 170 device. The computing device 200 may include a bus 210, a processor 220, a memory 230, a data storage 240, an input/output device 250, and a communication interface 260. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing a client usage telemetry data, the active synthetic data, a performance benchmark, or a failure threshold.

The input/output device 250 may include one or more conventional mechanisms that permit a user to input information to the computing device 200, such as a keyboard, a mouse, a voice recognition device, a microphone, a headset, a gesture recognition device, a touch screen, etc. The input/output device 250 may include one or more conventional mechanisms that output information to the user, including a display, a printer, one or more speakers, a headset, or a medium, such as a memory, or a magnetic or optical disk and a corresponding disk drive. The communication interface 260 may include any transceiver-like mechanism that enables computing device 200 to communicate with other devices or networks. The communication interface 260 may include a network interface or a transceiver interface. The communication interface 260 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

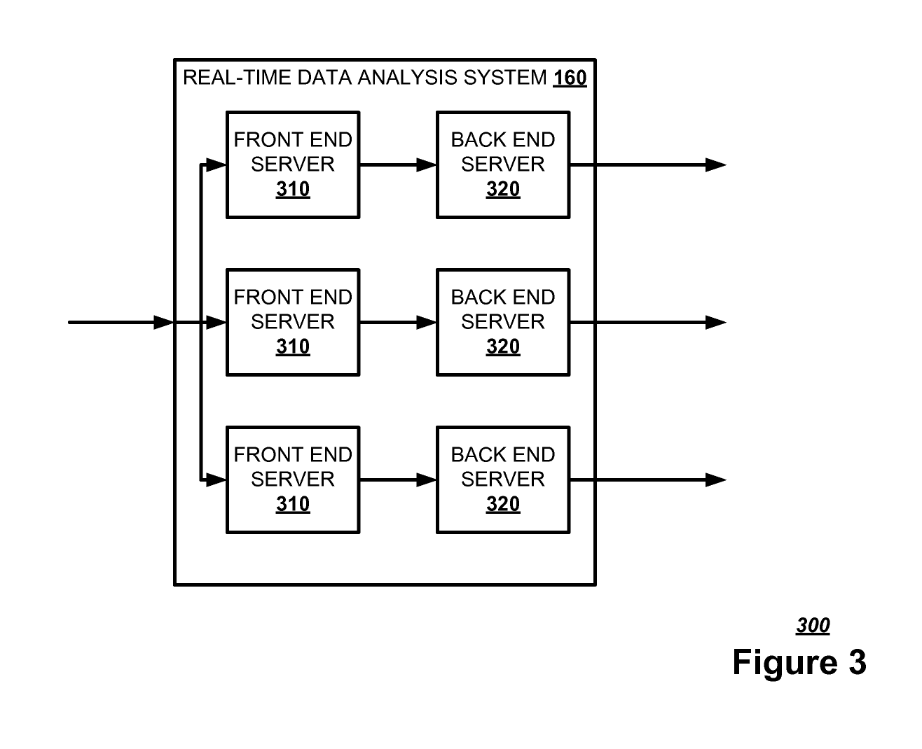

FIG. 3 illustrates, in a block diagram, one embodiment of a real-time data analysis interaction 300. The real-time data analysis system 160 may receive the service signal from either a network service client 112, a telemetry agent 140, or an active monitoring system 150. The real-time data analysis system 160 may direct the service signal to a front end server 310. The front end server 310 may direct the service signal to a back end server 320 for processing. The back end server 320 may determine the service signal indicates an emergency event. The back end server 320 may identify a service technician 170 to handle the emergency event. The back end server 320 may send an emergency alert to the service technician 170, suppressing any successive alerts.

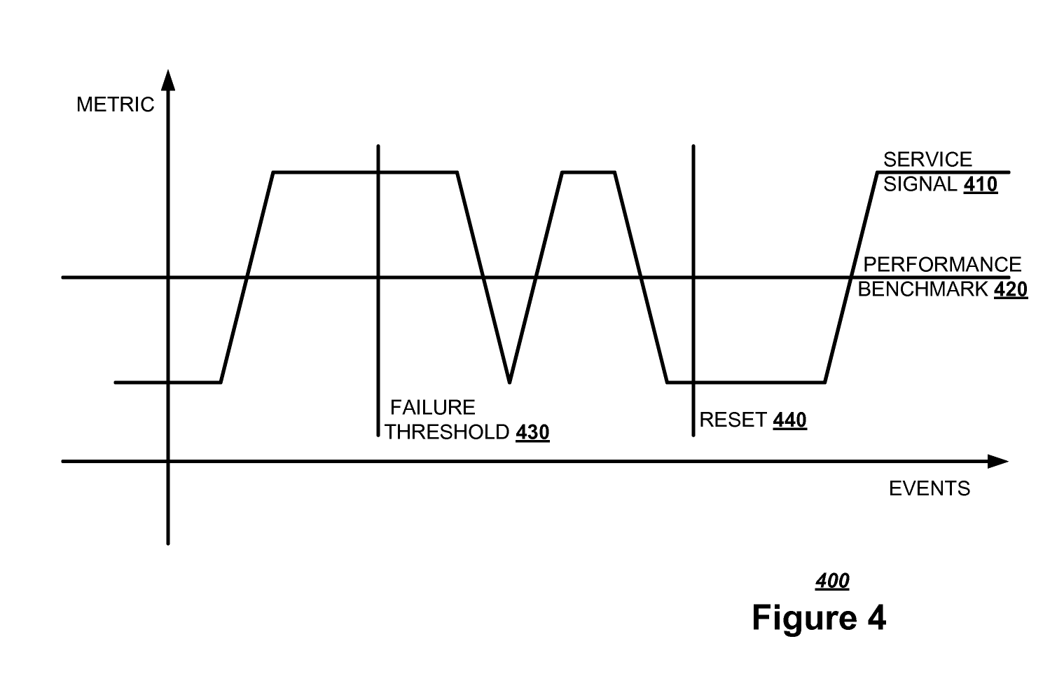

FIG. 4 illustrates, in a line graph, one embodiment of a real-time data analysis 400 of a service signal 410. In one embodiment, the service signal 410 may represent a metric for a set of events received at regular intervals. The metric may represent the amount of time between an access of the network service 120 and a response. If the response time is below a performance benchmark 420, the event is a success event. If the response time is above a performance benchmark 420, the event is a failure event. Alternately, the service signal 410 may be a binary representation of the success or failure of an access response, with a “0” representing failure and a “1” representing success.

The real-time data analysis system 160 may use a failure threshold 430 to discount momentary failures that do not represent true emergency events. For example, a service signal 410 may have to indicate three consecutive failure events for the real-time data analysis system 160 to identify emergency event. The real-time data analysis system 160 may then send an emergency alert to the service technician 170. The service signal 410 may have a service status of emergency. The service status may remain in emergency status, even if the service signal 410 is representing success events, until the service technician 170 has initiated a reset 440. The real-time data analysis system 160 may suppress successive alerts while the service signal 410 has emergency status. Once the service status has been reset 440, the real-time data analysis system 160 may send a new emergency alert if the service signal 410 crosses the failure threshold 430.

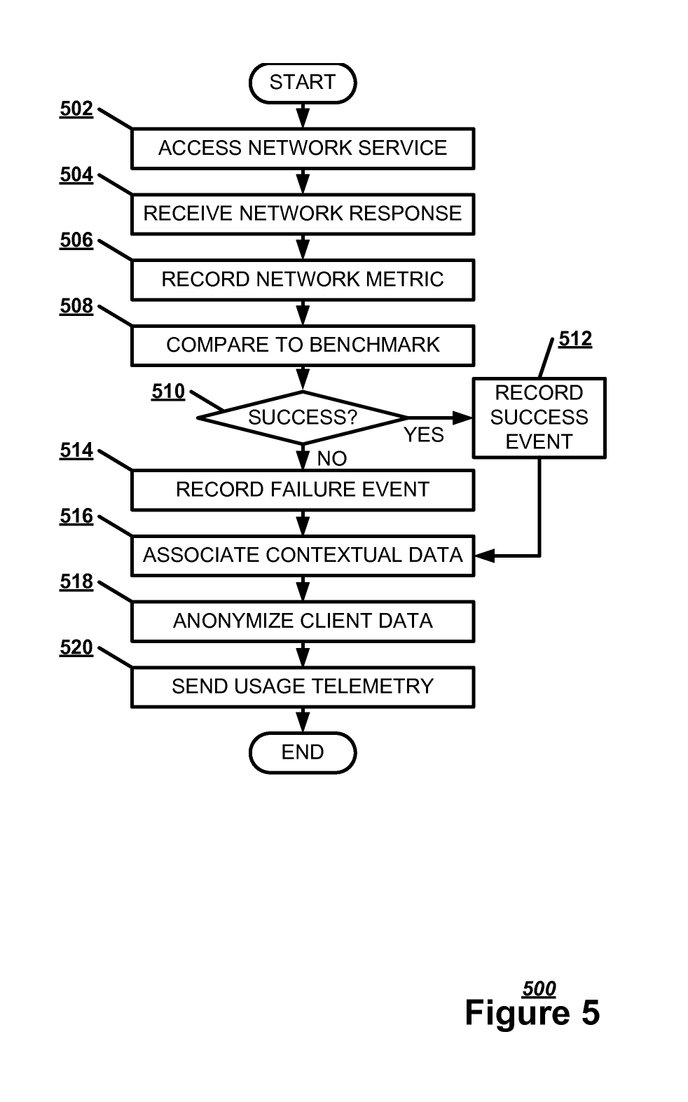

Different actions may be executed at a network service client 112, a telemetry agent 140, or at a real-time data analysis system 160. FIG. 5 illustrates, in a flowchart, one embodiment of a method 500 of generating a client usage telemetry data set with a network service client 112. The network service client 112 may access a network service 120 (Block 502). The network service client 112 may receive a network response from the network service 120 (Block 504). The network service client 112 may record a network metric describing the network service 120, such as the network response time (Block 506). The network service client 112 may compare the network metric to a performance benchmark (Block 508). If the network metric indicates the network event is a success event (Block 510), the network service client 112 may record an event notice as a success notice (Block 512). If the network metric indicates the network event is a failure event (Block 510), the network service client 112 may record an event notice as a failure notice (Block 514). The network service client 112 may send just the failure notices to the real-time data analysis system 160, or send both the success notices and the failure notices. The network service client 112 may send a set of previous success notices upon the occurrence of a failure event. The network service client 112 may associate a contextual data set associated with an event notice (Block 516). A contextual data set may describe the circumstances surrounding the network event, such as response time, previous response times, time of day, network configuration, and other data. The network service client 112 may anonymize any client data associated with event notices (Block 518). The network service client 112 may send the client usage telemetry data set to a telemetry agent 140 or a real-time data analysis system 160 (Block 520).

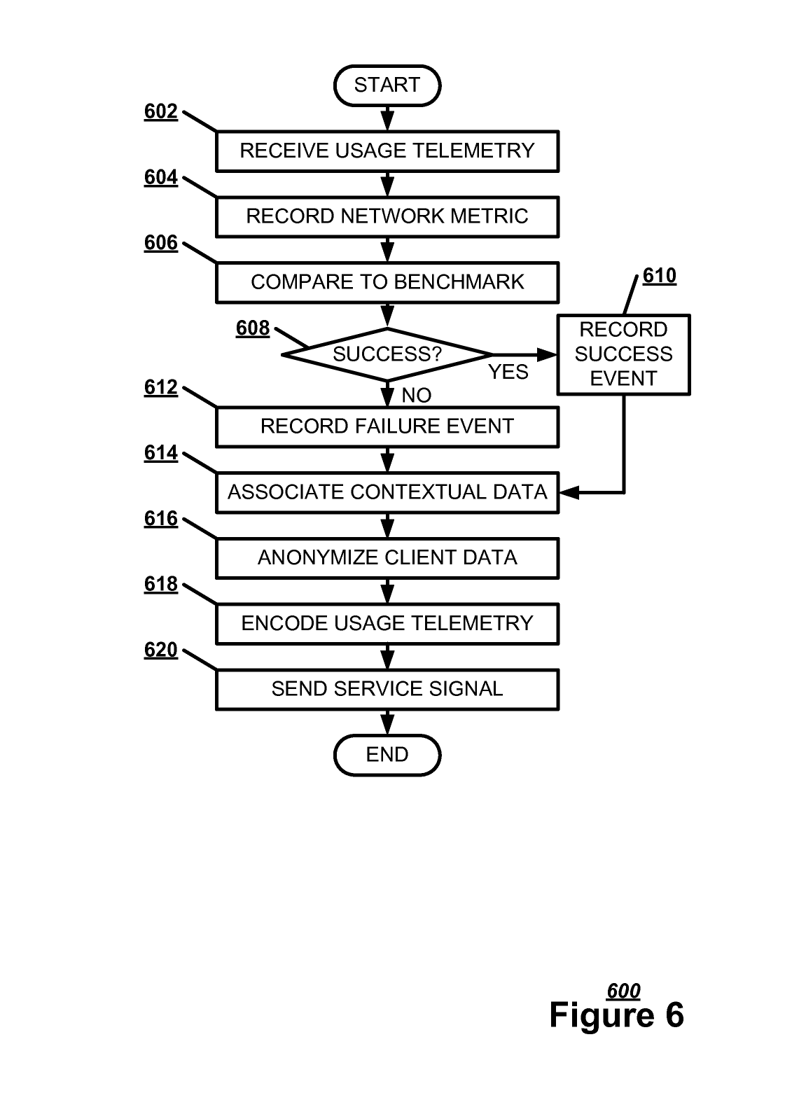

FIG. 6 illustrates, in a flowchart, one embodiment of a method 600 of generating a service signal 410 with a telemetry agent 140. The telemetry agent 140 may receive a client usage telemetry data set from the network service client 112 (Block 602). The telemetry agent 140 may record a network metric describing the network service 120, such as the network response time (Block 604). The telemetry agent 140 may compare the network metric to a performance benchmark (Block 606). If the network metric indicates the network event is a success event (Block 608), the telemetry agent 140 may record an event notice as a success notice (Block 610). If the network metric indicates the network event is a failure event (Block 608), the telemetry agent 140 may record an event notice as a failure notice (Block 612). The telemetry agent 140 may associate a contextual data set associated with an event notice (Block 614). The telemetry agent 140 may anonymize any client data associated with event notices (Block 616). The telemetry agent 140 encode the client usage telemetry data set in a service signal 410 (Block 618). The telemetry agent 140 may send the service signal 410 to a real-time data analysis system 160 (Block 620).

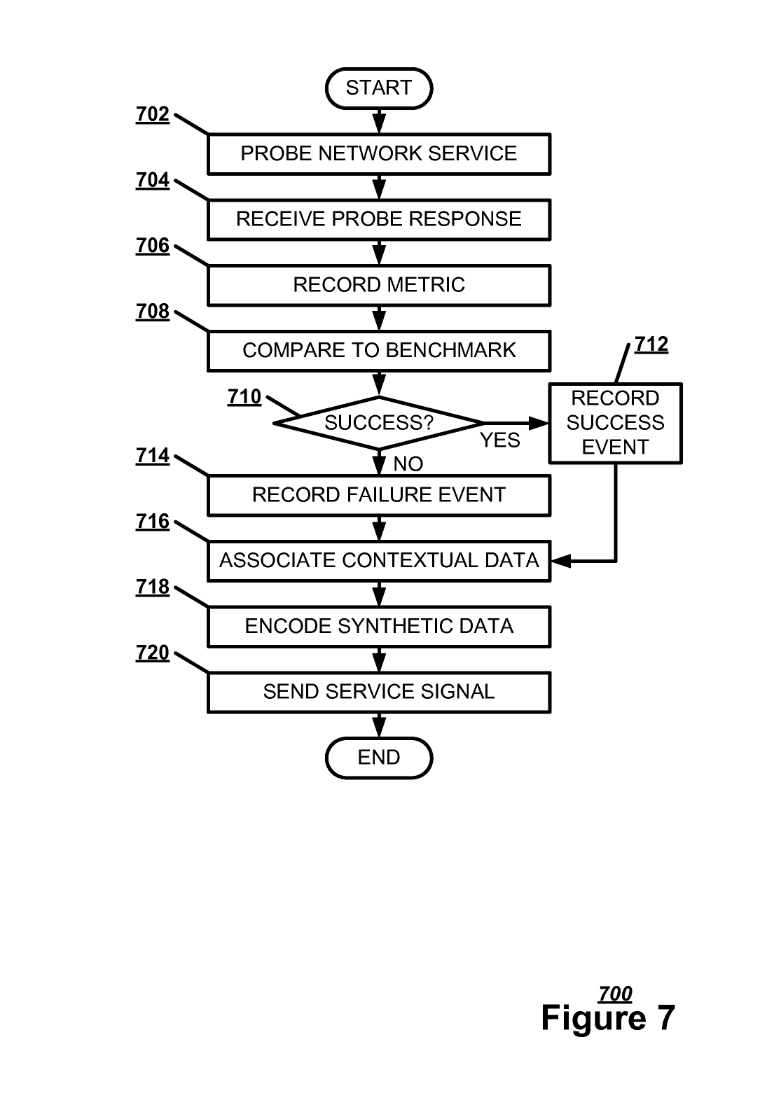

FIG. 7 illustrates, in a flowchart, one embodiment of a method 700 of generating a service signal 400 with an active monitoring service 150. The active monitoring service 150 may probe a network service 120 (Block 702). The active monitoring service 150 may receive a probe response from the network service 120 (Block 704). The active monitoring service 150 may record a network metric describing the network service 120, such as the probe response time (Block 706). The active monitoring service 150 may compare the network metric to a performance benchmark 420 (Block 708). If the network metric indicates the network event is a success event (Block 710), the active monitoring service 150 may record an event notice as a success notice (Block 712). If the network metric indicates the network event is a failure event (Block 710), the active monitoring service 150 may record an event notice as a failure notice (Block 714). The active monitoring service 150 may associate a contextual data set associated with an event notice (Block 716). The active monitoring service 150 encode the active synthetic data set in a service signal 410 (Block 718). The active monitoring service 150 may send the service signal 410 to a real-time data analysis system 160 (Block 720).

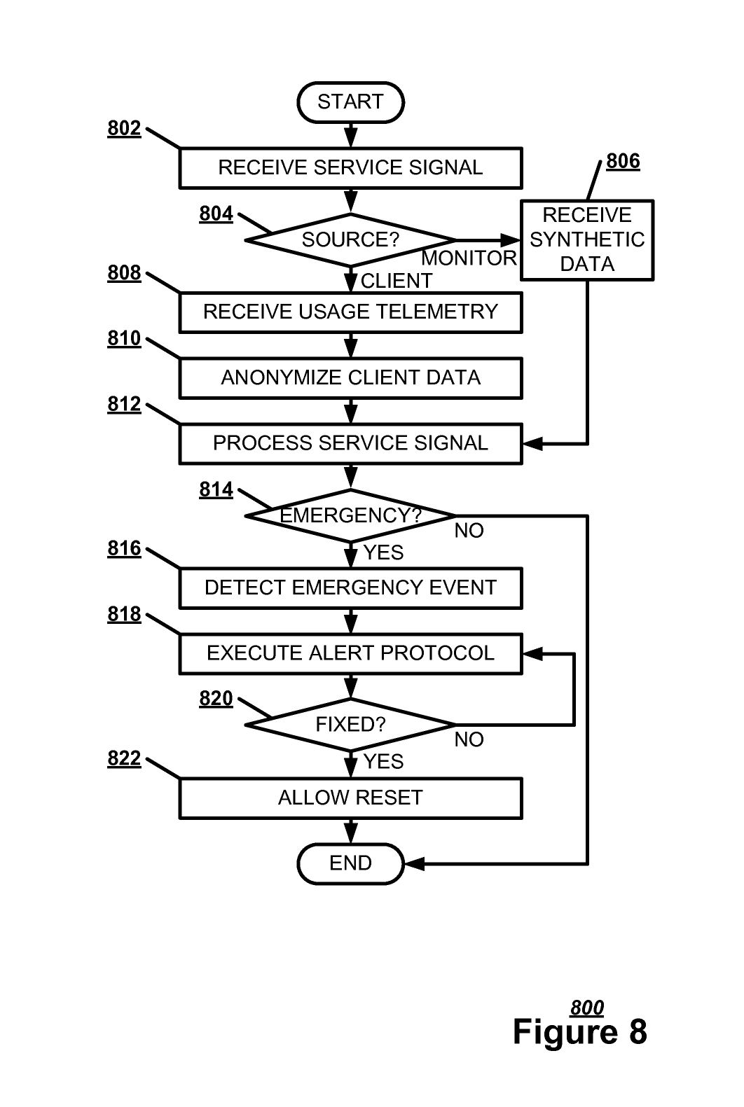

FIG. 8 illustrates, in a flowchart, one embodiment of a method 800 of processing a service signal 400 at a real-time data analysis system 160. The real-time data analysis system 160 may receive a service signal 410 from an application interacting with a network service 120 (Block 802). If the application is an active monitoring service 150 (Block 804), the real-time data analysis system 160 may receive an active synthetic data set in the service signal 410 from an active monitoring service 150 (Block 806). If the application is a network service client 112 (Block 804), the real-time data analysis system 160 may receive a client usage telemetry data set in the service signal 410 from a network service client 112 (Block 808). The real-time data analysis system 160 may anonymize a client usage telemetry data set in the service signal 410 (Block 810). The real-time data analysis system 160 may process the service signal 410 from the application interacting with a network service 120 (Block 812). If the real-time data analysis system 160 determines that the service signal 410 crosses a failure threshold 430 indicating an emergency event (Block 814), the real-time data analysis system 160 may detect the emergency event based on the service signal 410 (Block 816). The real-time data analysis system 160 may execute an emergency alert protocol (Block 818). If a service technician has fixed the issue (Block 820), the real-time data analysis system 160 may allow the service technician 170 to reset a service status (Block 822).

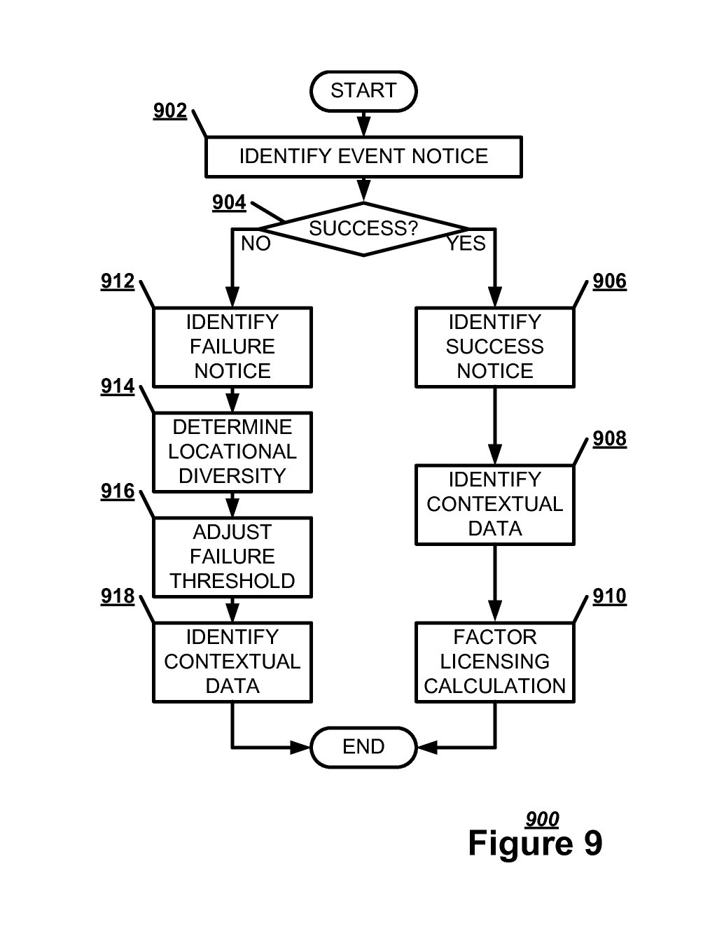

FIG. 9 illustrates, in a flowchart, one embodiment of a method 900 of processing the service signal 410 at a real-time data analysis system 160. The real-time data analysis system 160 may identify an event notice in the service signal 410 (Block 902). If the event notice is a success notice (Block 904), the real-time data analysis system 160 may identify the success notice in the service signal 410 (Block 906). The real-time data analysis system 160 may identify a contextual data set associated with the event notice in the service signal (Block 908). The real-time data analysis system 160 may factor a success notice in the service signal 410 into a licensing agreement calculation (Block 910).

If the event notice is a failure notice (Block 904), the real-time data analysis system 160 may identify a failure notice in the service signal 410 (Block 912). The real-time data analysis system 160 may determine a locational diversity for the set of event notices received (Block 914). The real-time data analysis system 160 may adjust a failure threshold based on the location diversity of a set of event notices (Block 916). The real-time data analysis system 160 may identify a contextual data set associated with the event notice in the service signal (Block 918).

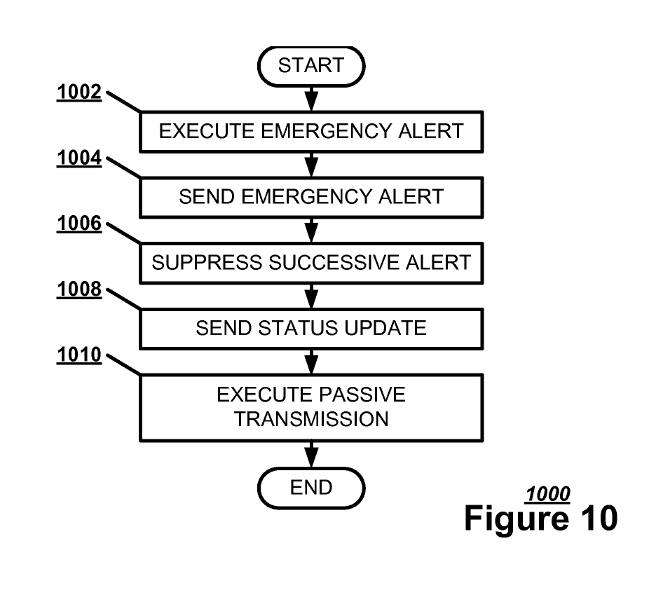

FIG. 10 illustrates, in a flowchart, one embodiment of a method 1000 of executing an alert protocol at a real-time data analysis system 160. The real-time data analysis system 160 may execute an emergency alert as an intrusive transmission interrupting the service technician 170 (Block 1002). The real-time data analysis system 160 may send an emergency alert about the emergency event to a service technician 170 (Block 1004). The real-time data analysis system 160 may suppress a successive alert about the emergency event (Block 1006). The real-time data analysis system 160 may send a status update about the emergency event (Block 1008). The real-time data analysis system 160 may execute the status update as a passive transmission without interrupting the service technician 170 (Block 1010).

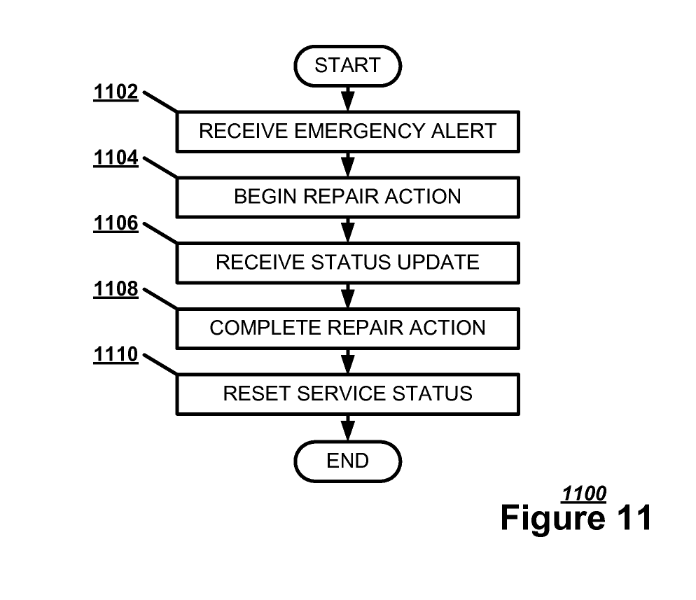

FIG. 11 illustrates, in a flowchart, one embodiment of a method 1100 of repairing a network service 120 with a service technician 170. The service technician 170 may receive an emergency alert from the real-time data analysis system 160 (Block 1102). The service technician 170 may begin a repair action on the network service 120 (Block 1104). The service technician 170 may receive a status update from the real-time data analysis system 160 (Block 1106). The service technician 170 may complete the repair action (Block 1108). The service technician 170 may reset the service status of the network service 120 (Block 1110).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
processing a service signal from an application interacting with a network service;
detecting an emergency event based on the service signal;
sending an emergency alert about the emergency event; and
suppressing a successive alert about the emergency event.

2. The method of claim 1, further comprising:
executing an emergency alert as an intrusive transmission.

3. The method of claim 1, further comprising:
sending a status update about the emergency event.

4. The method of claim 1, further comprising:
executing a status update as a passive transmission.

5. The method of claim 1, further comprising:
receiving an active synthetic data set in the service signal from an active monitoring service.

6. The method of claim 1, further comprising:
receiving a client usage telemetry data set in the service signal from a network service client.

7. The method of claim 1, further comprising:
anonymizing a client usage telemetry data set in the service signal.

8. The method of claim 1, further comprising:
determining that the service signal crosses a failure threshold indicating the emergency event.

9. The method of claim 1, further comprising:
allowing a service technician to reset a service status.

10. A tangible machine-readable medium having a set of instructions detailing a method stored thereon that when executed by one or more processors cause the one or more processors to perform the method, the method comprising:
processing a service signal from an application interacting with a network service;
determining that the service signal crosses a failure threshold indicating an emergency event; and
sending an emergency alert about the emergency event.

11. The tangible machine-readable medium of claim 10, wherein the method further comprises:
suppressing a successive alert about the emergency event.

12. The tangible machine-readable medium of claim 10, wherein the method further comprises:
receiving an active synthetic data set in the service signal from an active monitoring service.

13. The tangible machine-readable medium of claim 10, wherein the method further comprises:
receiving a client usage telemetry data set in the service signal from a network service client.

14. The tangible machine-readable medium of claim 10, wherein the method further comprises:
identifying a failure notice in the service signal.

15. The tangible machine-readable medium of claim 10, wherein the method further comprises:
adjusting the failure threshold based on locational diversity of a set of event notices.

16. The tangible machine-readable medium of claim 10, wherein the method further comprises:
identifying a success notice in the service signal.

17. The tangible machine-readable medium of claim 10, wherein the method further comprises:
factoring a success notice in the service signal into a licensing agreement calculation.

18. The tangible machine-readable medium of claim 10, wherein the method further comprises:
identifying a contextual data set associated with an event notice in the service signal.

19. A real-time data analysis system, comprising:
a memory that stores a service signal from an application interacting with a network service;
a communication interface that sends an emergency alert about an emergency event detected based on the service signal; and
a processor that determines that the service signal crosses a failure threshold indicating the emergency event and suppresses a successive alert about the emergency event.

20. The real-time data analysis system of claim 19, wherein the communication interface receives the service signal from at least one of an active monitoring system and a network service client.
